(19) United States
(12) Patent Application Publication
(10) Pub. No.: US 2026/0229179 A1
(43) Pub. Date: Aug. 6, 2026

(54) DISPLAY DEVICE, ELECTRONIC DEVICE INCLUDING THE SAME, AND METHOD OF DRIVING THE DISPLAY DEVICE

(71) Applicant: Samsung Display Co., LTD., Yongin-si (KR)

(72) Inventor: SI-BEAK PYO, Yongin-si (KR)

(21) Appl. No.: 19/405,621

(22) Filed: Dec. 2, 2025

(30) Foreign Application Priority Data
Feb. 4, 2025 (KR) 10-2025-0013447

(51) Int. Cl. G09G 3/3233; G09G 3/20; G09G 3/3266

(52) U.S. Cl. CPC G09G 3/3233; G09G 3/2007; G09G 3/3266; G09G 2300/0819; G09G 2300/0842; G09G 2300/0861; G09G 2310/08; G09G 2320/0238; G09G 2320/0252; G09G 2320/0626; G09G 2320/066; G09G 2340/0435; G09G 2360/16

(57) ABSTRACT

A display device operates in a first mode or a second mode. A light emission control signal includes a first non-light-emission period in the first mode and a second non-light-emission period in the second mode, a black scan signal includes a first activation period in the first mode, the black scan signal includes a second activation period and a correction activation period in the second mode. A time interval between a start point of the first non-light-emission period and a start point of the first activation period is equal to a time interval between a start point of the second non-light-emission period and a start point of the correction activation period.

This application claims priority to Korean Patent Application No. 10-2025-0013447, filed on Feb. 4, 2025, and all the benefits accruing therefrom under 35 U.S.C. § 119, the content of which in its entirety is herein incorporated by reference.

### BACKGROUND

### 1. Field

The present disclosure relates to a display device, an electronic device including the display device, and a method of driving the display device. More particularly, the present disclosure relates to a display device with improved display quality, an electronic device including the display device, and a method of driving the display device.

### 2. Description of Related Art

Among display devices, a light emitting type display device displays images using a light emitting diode that emits light through the recombination of holes and electrons. The light emitting type display device has various desired characteristics such as a fast response time, a low power consumption, etc.

The display device typically includes a display panel for displaying images, a gate driver for sequentially applying scan signals to scan lines arranged in the display panel, a data driver for applying data signals to data lines arranged in the display panel, and a voltage generator for applying voltages to voltage lines arranged in the display panel.

### SUMMARY

The present disclosure provides a display device with improved display quality, an electronic device including the display device, and a method of driving the display device.

Embodiments of the invention provide a display device including a pixel which operates in a first mode or a second mode, a scan driver which applies a black scan signal to the pixel, and a light emission driver which applies a light emission control signal to the pixel. In such embodiments, the light emission control signal includes a first non-light-emission period in the first mode and a second non-light-emission period in the second mode, the first non-light-emission period has a duration different from a duration of the second non-light-emission period, the black scan signal includes a first activation period in the first mode, the black scan signal includes a second activation period and a correction activation period in the second mode, and a time interval between a start point of the first non-light-emission period and a start point of the first activation period is equal to a time interval between a start point of the second non-light-emission period and a start point of the correction activation period.

In an embodiment, the first activation period may overlap the first non-light-emission period in the first mode, and the second activation period and the correction activation period may overlap the second non-light-emission period in the second mode.

In an embodiment, the correction activation period may precede the second activation period in the second mode.

In an embodiment, the first activation period may be the earliest activation period among a plurality of activation periods included in the black scan signal during a driving frame in the first mode.

In an embodiment, the duration of the first non-light-emission period may be shorter than the duration of the second non-light-emission period.

In an embodiment, the pixel may emit a light at a first target luminance in the first mode and emit a light at a second target luminance in the second mode, and the first target luminance may be higher than the second target luminance.

In an embodiment, the first target luminance may be greater than or equal to a reference luminance, and the second target luminance may be smaller than the reference luminance.

In an embodiment, the pixel may emit the light at a lower luminance as the duration of the first non-light-emission period and the duration of the second non-light-emission period may become longer.

In an embodiment, the display device may further include a driving controller which controls an operation of the scan driver and the light emission driver. In such an embodiment, the driving controller may include a determiner which receives a luminance adjustment value and determines whether the luminance adjustment value is greater than or equal to a reference value, a first compensator which corrects a luminance of the pixel when the luminance adjustment value is greater than or equal to the reference value, a second compensator which corrects the luminance of the pixel when the luminance adjustment value is smaller than the reference value, and a lookup table which stores a plurality of luminance adjustment values, a plurality of target luminances corresponding to the luminance adjustment values, and a plurality of light emission ratios corresponding to the target luminances.

In an embodiment, the first compensator may correct the luminance of the pixel using a luminance control signal, and the second compensator may correct the luminance of the pixel using the light emission ratios.

In an embodiment, the duration of the first non-light-emission period and the duration of the second non-light-emission period of the light emission control signal may be set based on the light emission ratios.

In an embodiment, The duration of the first non-light-emission period may be constant independently of the luminance adjustment value in the first mode, and the duration of the second non-light-emission period may be changed depending on the luminance adjustment value in the second mode.

In an embodiment, the luminance adjustment values greater than or equal to the reference value may correspond to a same light emission ratio in the lookup table.

In an embodiment, the display device may operate at a first driving frequency during a first driving frame or at a second driving frequency during a second driving frame.

In an embodiment, the first driving frame and the second driving frame may include a write frame, the light emission control signal may include the first non-light-emission period during the write frame in the first mode, the black scan signal may include the first activation period during the write frame in the first mode, the light emission control signal may include the second non-light-emission period during the write frame in the second mode, and the black scan signal may include the second activation period during the write frame in the second mode.

In an embodiment, the second driving frame may further include a holding frame, the black scan signal may include a first holding activation period during the holding frame in the first mode, and the black scan signal may include a second holding activation period during the holding frame in the second mode.

In an embodiment, the pixel may include a light emitting element and a pixel circuit connected to the light emitting element, and the pixel circuit may include a light emission control transistor which receives the light emission control signal, and a black transistor which receives the black scan signal.

Embodiments of the invention provide a method of driving a display device. In such embodiments, the method includes allowing a driving controller to receive a luminance adjustment value, comparing the luminance adjustment value with a reference value, outputting a target luminance corresponding to the luminance adjustment value and a light emission ratio corresponding to the luminance adjustment value, outputting a light emission control signal based on the light emission ratio, outputting a correction signal based on the light emission ratio when the luminance adjustment value is smaller than the reference value, and outputting a black scan signal including a correction activation period based on the correction signal.

In an embodiment, a time interval between a start point of a non-light-emission period of the light emission control signal and a start point of a activation period of the black scan signal may be constant.

Embodiments of the invention provide an electronic device including a display device and a processor which controls an operation of the display device. In such embodiments, the display device includes a pixel which operates in a first mode or a second mode, a scan driver which applies a black scan signal to the pixel, and a light emission driver which applies a light emission control signal to the pixel. In such an embodiment, the light emission control signal includes a first non-light-emission period in the first mode and a second non-light-emission period in the second mode, the first non-light-emission period has a duration different from a duration of the second non-light-emission period, the black scan signal includes a first activation period in the first mode, the black scan signal includes a second activation period and a correction activation period in the second mode, and a time interval between a start point of the first non-light-emission period and a start point of the first activation period is equal to a time interval between a start point of the second non-light-emission period and a start point of the correction activation period.

According to embodiments, the display device operates in the first mode or the second mode. The second mode is a mode in which the display device emits light at a lower luminance compared to the first mode. When the display device operates in the second mode, the black scan signal further includes the correction activation period to maintain a constant time interval between the start point of the non-light-emission period of the light emission control signal and the start point of the activation period of the black scan signal. Accordingly, even when the duration of the non-light-emission period of the light emission control signal increases, the time for the pixel to display a black grayscale is not delayed.

### BRIEF DESCRIPTION OF THE DRAWINGS

FIG. 1 is a perspective view illustrating a display device according to an embodiment of the present disclosure;

FIG. 2A is an exploded perspective view illustrating a display device according to an embodiment of the present disclosure;

FIG. 2B is a cross-sectional view illustrating a display device according to an embodiment of the present disclosure;

FIG. 3 is a block diagram illustrating a display device according to an embodiment of the present disclosure;

FIG. 4 is a circuit diagram illustrating a pixel according to an embodiment of the present disclosure;

FIG. 5 is a signal timing diagram illustrating an operation of a display device according to an embodiment of the present disclosure;

FIG. 6 is a signal timing diagram illustrating a variation of a light emission control signal and a black scan signal based on a mode according to an embodiment of the present disclosure;

FIG. 7 is a signal timing diagram illustrating an operation of a display device according to an embodiment of the present disclosure;

FIG. 8 is a signal timing diagram illustrating a variation of a light emission control signal and a black scan signal based on a mode according to an embodiment of the present disclosure;

FIG. 9 is a block diagram illustrating a driving controller according to an embodiment of the present disclosure;

FIG. 10 is a lookup table according to an embodiment of the present disclosure;

FIG. 11 is a flowchart illustrating an operation of a display device according to an embodiment of the present disclosure;

FIG. 12 is a block diagram illustrating an electronic device according to an embodiment of the present disclosure; and

FIG. 13 are schematic views illustrating electronic devices according to various embodiments of the present disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present. In the present disclosure, it will be understood that when an element (or area, layer, or portion) is referred to as being “connected to” or “coupled to” another element or layer, it can be directly connected or coupled to the other element or layer or intervening elements or layers may be present.

Like numerals refer to like elements throughout. In the drawings, the thickness, ratio, and dimension of components are exaggerated for effective description of the technical content.

It will be understood that, although the terms “first,” “second,” “third”etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Furthermore, relative terms, such as “lower” or “bottom” and “upper”or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described with reference to the accompanying drawings.

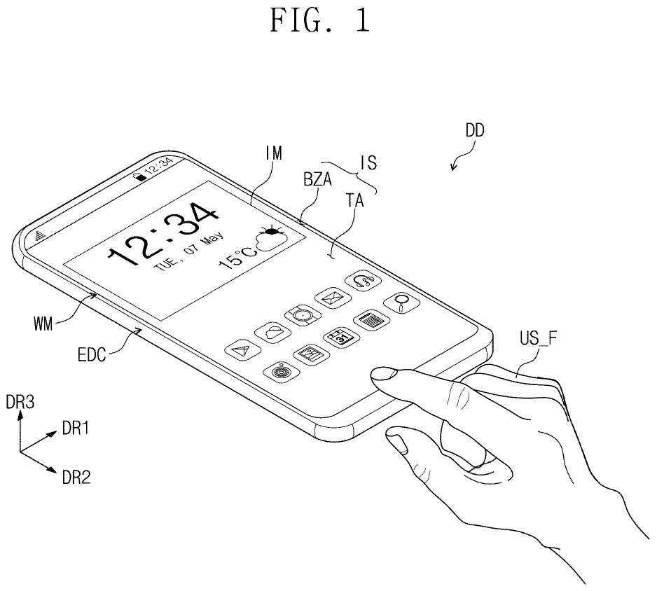

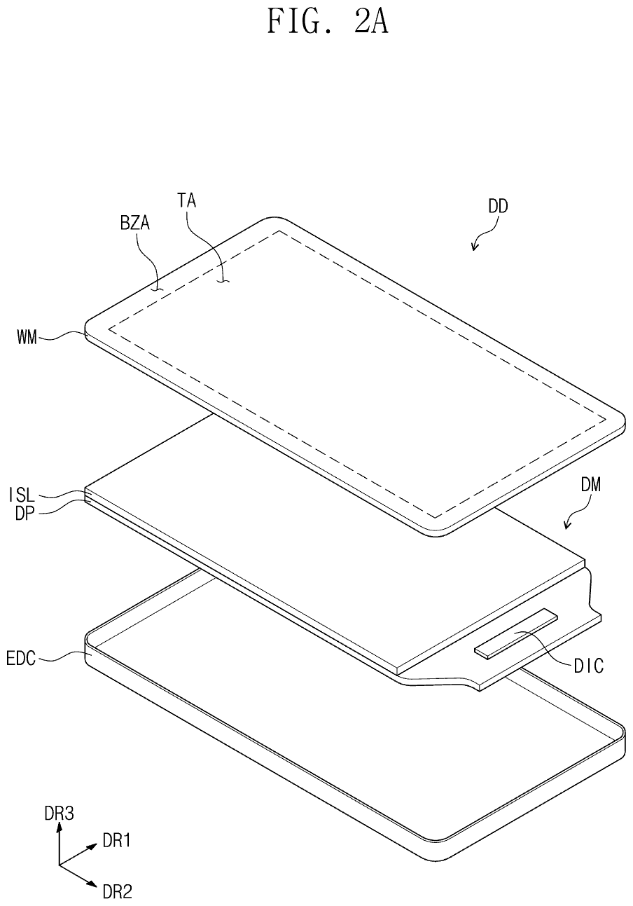

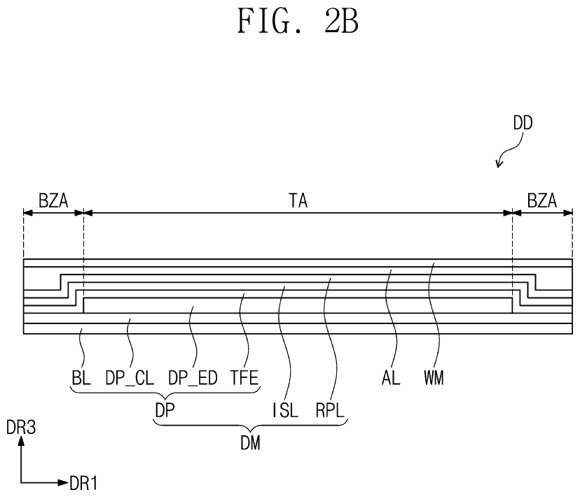

FIG. 1 is a perspective view illustrating a display device according to an embodiment of the present disclosure. FIG. 2A is an exploded perspective view illustrating the display device according to an embodiment of the present disclosure. FIG. 2B is a cross-sectional view illustrating the display device according to an embodiment of the present disclosure.

Referring to FIGS. 1 and 2A, an embodiment of the display device DD may have a rectangular shape with short sides parallel to a first direction DR1 and long sides parallel to a second direction DR2 intersecting the first direction DR1. However, the shape of the display device DD should not be limited to the rectangular shape, and the display device DD may have a variety of shapes, such as a circular shape, a polygonal shape, or the like.

The display device DD may be activated in response to electrical signals. The display device DD may be implemented in various embodiments. As an example, the display device DD may be applied to electronic devices, such as a smartwatch, a tablet computer, a notebook computer, a computer, a smart television, etc. That is, various embodiments of the electronic device may include the display device DD.

Hereinafter, a normal line direction, which is substantially perpendicular to a plane defined by the first direction DR1 and the second direction DR2, is referred to as a third direction DR3. In the following descriptions, the expression “when viewed on a plane” or “in a plan view” may refer to a state of being viewed in the third direction DR3.

An upper surface of the display device DD may be defined as a display surface IS and may be substantially parallel to the plane defined by the first direction DR1 and the second direction DR2. Images IM generated by the display device DD may be provided to a user through the display surface IS.

The display surface IS may be divided into a transmission area TA and a bezel area BZA. The images IM may be displayed through the transmission area TA. The user may view the images IM through the transmission area TA. In an embodiment, as shown in FIG. 2A, the transmission area TA may have a quadrangular shape with rounded vertices. However, this is merely an example, and the transmission area TA may have a variety of shapes and should not be particularly limited.

The bezel area BZA may be defined adjacent to the transmission area TA. The bezel area BZA may have a selected color. The bezel area BZA may surround the transmission area TA in a plan view. Accordingly, the shape of the transmission area TA may be defined by the bezel area BZA, however, this is merely an example. According to another embodiment, the bezel area BZA may be disposed adjacent to only one side of the transmission area TA or may be omitted.

The display device DD may sense an external input provided from the outside. The external input may include a variety of external inputs provided from the outside. In an embodiment, for example, the external input may include an external input (e.g., a hovering input) detected when in proximity to or approaching close to the display device DD at a selected distance, as well as a touch input from a part of the user's body, e.g., a hand of the user US_F or from a separate device, e.g., an active pen, a digitizer, or the like. In addition, the external input may take various forms, such as force, pressure, temperature, or light.

The display device DD may include a window WM, a display module DM, and a housing EDC. In an embodiment, the window WM and the housing EDC may be coupled to each other to form the exterior of the display device DD.

A front surface of the window WM may define the display surface IS of the display device DD. The window WM may include an optically transparent insulating material. In an embodiment, for example, the window WM may include a glass or plastic material. The window WM may have a single-layer or multi-layer structure. In an embodiment, for example, the window WM may include a plurality of plastic films coupled to each other by an adhesive or a glass substrate and a plastic film coupled to the glass substrate by an adhesive.

The display module DM may include a display panel DP and an input sensing layer ISL. The display panel DP may display images in response to electrical signals, and the input sensing layer ISL may sense external inputs provided from the outside. The external inputs may be provided in various forms.

The display panel DP according to an embodiment of the present disclosure may be a light-emitting type display panel, however, it should not be particularly limited. In an embodiment, the display panel DP may be an organic light emitting display panel, an inorganic light emitting display panel, or a quantum dot light emitting display panel. A light emitting layer of the organic light emitting display panel may include an organic light emitting material, and a light emitting layer of the inorganic light emitting display panel may include an inorganic light emitting material. A light emitting layer of the quantum dot light emitting display panel may include a quantum dot and a quantum rod. Hereinafter, for convenience of description, embodiments where the display panel DP is the organic light emitting display panel will be described as a representative example.

Referring to FIG. 2B, an embodiment of the display panel DP may include a base layer BL, a circuit layer DP_CL, an element layer DP_ED, and an encapsulation layer TFE. The display panel DP may be a flexible display panel, however, the present disclosure should not be limited thereto or thereby. In an embodiment, for example, the display panel DP may be a foldable display panel folded with respect to a folding axis or a rigid display panel.

The base layer BL may include a synthetic resin layer. The synthetic resin layer may be a polyimide-based resin layer, however, a material for the synthetic resin layer should not be particularly limited. In an embodiment, the base layer BL may include a glass substrate, a metal substrate, or an organic/inorganic composite material substrate.

The circuit layer DP_CL may be disposed on the base layer BL. The circuit layer DP_CL may be disposed between the base layer BL and the element layer DP_ED. The circuit layer DP_CL may include at least one insulating layer and a circuit element. Hereinafter, the insulating layer included in the circuit layer DP_CL is referred to as an intermediate insulating layer. The intermediate insulating layer may include at least one intermediate inorganic layer and at least one intermediate organic layer. The circuit element may include a pixel driving circuit included in each of pixels for displaying the images and a sensor driving circuit included in each of sensors for sensing external information. The external information may be the biometric information. In an embodiment, for example, the sensor may be a fingerprint recognition sensor, a proximity sensor, an iris recognition sensor, a blood pressure measurement sensor, an illumination sensor, or the like. In addition, the sensor may be an optical sensor that recognizes the biometric information in an optical manner. The circuit layer DP_CL may further include signal lines connected to the pixel driving circuit and/or the sensor driving circuit.

The element layer DP_ED may include a light emitting element included in each of the pixels and a light receiving element included in each of the sensors. In an embodiment, for example, the light receiving element may be a photodiode. The light receiving element may be a sensor that senses a light reflected by a user's fingerprint or responds to the light.

The encapsulation layer TFE may encapsulate the element layer DP_ED. The encapsulation layer TFE may include at least one organic layer and at least one inorganic layer. The inorganic layer may include an inorganic material and may protect the element layer DP_ED from moisture and oxygen. The inorganic layer may include a silicon nitride layer, a silicon oxynitride layer, a silicon oxide layer, a titanium oxide layer, or an aluminum oxide layer, however, it should not be particularly limited. The organic layer may include an organic material and may protect the element layer DP_ED from a foreign substance such as dust particles.

The input sensing layer ISL may be disposed on the display panel DP. The input sensing layer ISL may be disposed directly on the encapsulation layer TFE. The input sensing layer ISL may be formed on the display panel DP through a continuous process. That is, in an embodiment where the input sensing layer ISL is disposed directly on the display panel DP, no adhesive film is disposed between the input sensing layer ISL and the encapsulation layer TFE. In another embodiment, an adhesive film may be disposed between the input sensing layer ISL and the display panel DP. In such an embodiment, the input sensing layer ISL may not be formed through a continuous process with the display panel DP, and the input sensing layer ISL may be fixed onto an upper surface of the display panel DP by the adhesive film after being formed separately from the display panel DP.

The input sensing layer ISL may sense the external input, e.g., a user's touch, may convert the external input to an input signal, and may apply the input signal to the display panel DP. The input sensing layer ISL may include a plurality of sensing electrodes to sense the external input. The sensing electrodes may sense the external input by a capacitance method. The display panel DP may receive an input signal from the input sensing layer ISL and may generate an image corresponding to the input signal.

The display module DM may further include an anti-reflective layer RPL. The anti-reflective layer RPL may reduce a reflectance of an external light incident to the display panel DP from the above of the display device DD. Due to the anti-reflective layer RPL, the external light may not be perceived by the user. According to an embodiment, the anti-reflective layer RPL may be disposed on the input sensing layer ISL, however, the present disclosure should not be limited thereto or thereby. According to another embodiment, the anti-reflective layer RPL may be disposed between the display panel DP and the input sensing layer ISL. In an embodiment, the anti-reflective layer RPL may include a plurality of color filters arranged to correspond to the pixels. The color filters may filter the external light to have the same color as the pixels. In such an embodiment, the external light may not be perceived by the user. However, the present disclosure should not be limited thereto or thereby, and the anti-reflective layer RPL may include a retarder and/or a polarizer to reduce the reflectance of the external light.

The display device DD may further include an adhesive layer AL. The window WM may be attached to the anti-reflective layer RPL by the adhesive layer AL. The adhesive layer AL may include an optically clear adhesive (OCA), an optically clear adhesive resin (OCR), or a pressure sensitive adhesive (PSA).

Referring back to FIG. 2A, the display module DM may further include a driving chip DIC. In an embodiment, for example, the driving chip DIC may be mounted on the display panel DP to be adjacent to one end of the display panel DP. However, alternatively, the driving chip DIC may be mounted on a flexible circuit film coupled to one side of the display panel DP.

The housing EDC may be coupled to the window WM. The housing EDC and the window WM coupled to the housing EDC may provide an inner space. The display module DM may be accommodated in the inner space. The housing EDC may include a material with a relatively high rigidity. In an embodiment, for example, the housing EDC may include a glass, plastic, or metal material or a plurality of frames and/or plates of combinations thereof. The housing EDC may stably protect the components of the display device DD accommodated in the inner space from external impacts. Although not shown in figures, a battery module may be disposed between the display module DM and the housing EDC to supply a power source required for an overall operation of the display device DD.

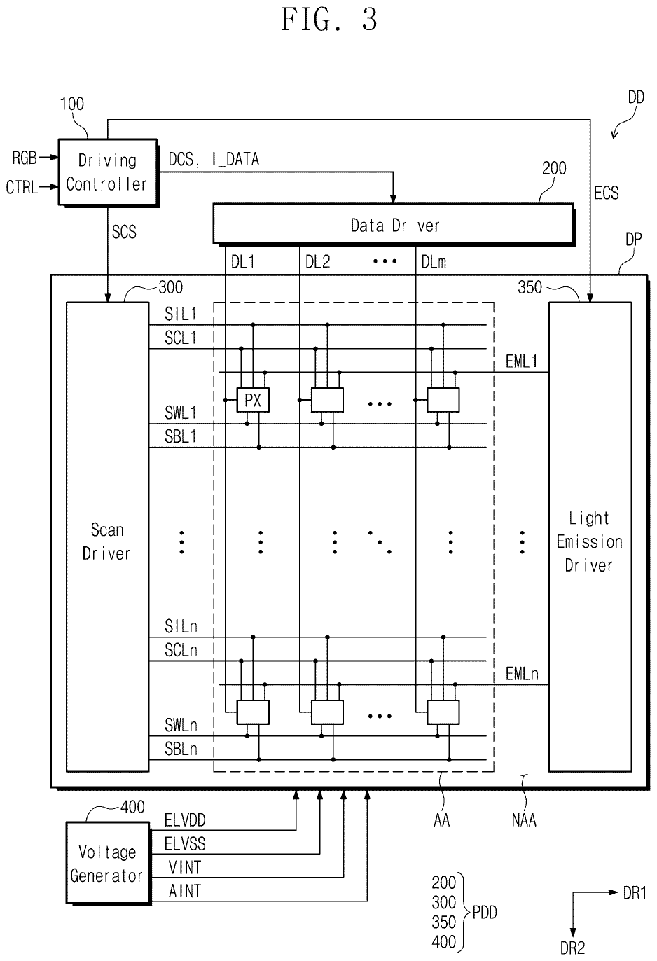

FIG. 3 is a block diagram illustrating the display device DD according to an embodiment of the present disclosure.

Referring to FIG. 3, an embodiment of the display device DD may include the display panel DP, a panel driver PDD, and a driving controller 100. The display panel DP may include the pixels. The pixels may receive a panel driving signal from the panel driver PDD and may emit lights in response to the panel driving signal. The panel driver PDD may generate the panel driving signal used to drive the display panel DP and may apply the generated panel driving signal to the display panel DP. In an embodiment, for example, the panel driver PDD may include a data driver 200, a scan driver 300, a light emission driver 350, and a voltage generator 400. In such an embodiment, the panel driving signal may include a data signal, a scan signal, a light emission control signal, and various voltages.

The driving controller 100 may receive an image signal RGB and control signals CTRL from a host processor. In an embodiment, for example, the host processor may include at least one selected from a central processing unit (CPU) and an application processor (AP). The host processor may further include at least one selected from a graphics processing unit (GPU), a communication processor (CP), and an image signal processor (ISP).

The driving controller 100 may include an interface conversion circuit and a timing control circuit. The driving controller 100 may convert a data format of the image signal RGB to a data format appropriate to an interface between the data driver 200 and the driving controller 100 to generate image data I_DATA. The control signals CTRL may include a vertical synchronization signal, an input data enable signal, a master clock signal, or the like. The driving controller 100 may generate a first driving control signal SCS, a second driving control signal DCS, and a third driving control signal ECS based on the control signals CTRL.

The data driver 200 may receive the second driving control signal DCS and the image data I_DATA from the driving controller 100. The data driver 200 may convert the image data I_DATA to data signals and may output the data signals to a plurality of data lines DL1 to DLm described later. The data signals may be analog voltages corresponding to grayscale values of the image data I_DATA.

The scan driver 300 may receive the first driving control signal SCS from the driving controller 100. The scan driver 300 may output scan signals to scan lines in response to the first driving control signal SCS.

The voltage generator 400 may generate various voltages required to operate the display panel DP. In an embodiment, as shown in FIG. 3, the voltage generator 400 may generate a first driving voltage ELVDD, a second driving voltage ELVSS, a first initialization voltage VINT, and a second initialization voltage AINT.

The display panel DP may further include initialization scan lines SIL1 to SILn, compensation scan lines SCL1 to SCLn, write scan lines SWL1 to SWLn, black scan lines SBL1 to SBLn, light emission control lines EML1 to EMLn, and the data lines DL1 to DLm. The display panel DP may include an active area AA and a non-active area NAA. The initialization scan lines SIL1 to SILn, the compensation scan lines SCL1 to SCLn, the write scan lines SWL1 to SWLn, the black scan lines SBL1 to SBLn, the light emission control lines EML1 to EMLn, the data lines DL1 to DLm, and the pixels PX may overlap or be disposed in the active area AA. The initialization scan lines SIL1 to SILn, the compensation scan lines SCL1 to SCLn, the write scan lines SWL1 to SWLn, the black scan lines SBL1 to SBLn, and the light emission control lines EML1 to EMLn may extend in the first direction DR1 and may be spaced apart from each other in the second direction DR2. The data lines DL1 to DLm may extend in the second direction DR2 and may be spaced apart from each other in the first direction DR1. Here, n and m are natural numbers greater than 1.

Each of the pixels PX may be electrically connected to the initialization scan lines SIL1 to SILn, the compensation scan lines SCL1 to SCLn, the write scan lines SWL1 to SWLn, the black scan lines SBL1 to SBLn, the light emission control lines EML1 to EMLn, and the data lines DL1 to DLm. In an embodiment, each of the pixels PX may be electrically connected to four scan lines and one light emission control line. In an embodiment, for example, as shown in FIG. 3, pixels arranged in a first row may be connected to a first initialization scan line SIL1, a first compensation scan line SCL1, a first write scan lines SWL1, a first black scan line SBL1, and a first light emission control line EML1. In addition, pixels arranged in an n-th row may be connected to an n-th initialization scan line SILn, an n-th compensation scan line SCLn, an n-th write scan line SWLn, an n-th black scan line SBLn, and an n-th light emission control line EMLn. However, the number of the scan lines and light emission control line connected to each of the pixels PX should not be limited thereto or thereby and may be modified in various ways.

The scan driver 300 and the light emission driver 350 may be arranged in the non-active area NAA of the display panel DP. In response to the first driving control signal SCS, the scan driver 300 may output initialization scan signals to the initialization scan lines SIL1 to SILn, may output compensation scan signals to the compensation scan lines SCL1 to SCLn, may output write scan signals to the write scan lines SWL1 to SWLn, and may output black scan signals to the black scan lines SBL1 to SBLn.

The light emission driver 350 may receive the third driving control signal ECS from the driving controller 100. The light emission driver 350 may output light emission control signals to the light emission control lines EML1 to EMLn in response to the third driving control signal ECS. According to an embodiment, the scan driver 300 may be connected to the light emission control lines EML1 to EMLn. In such an embodiment, the scan driver 300 may output the light emission control signals to the light emission control lines EML1 to EMLn.

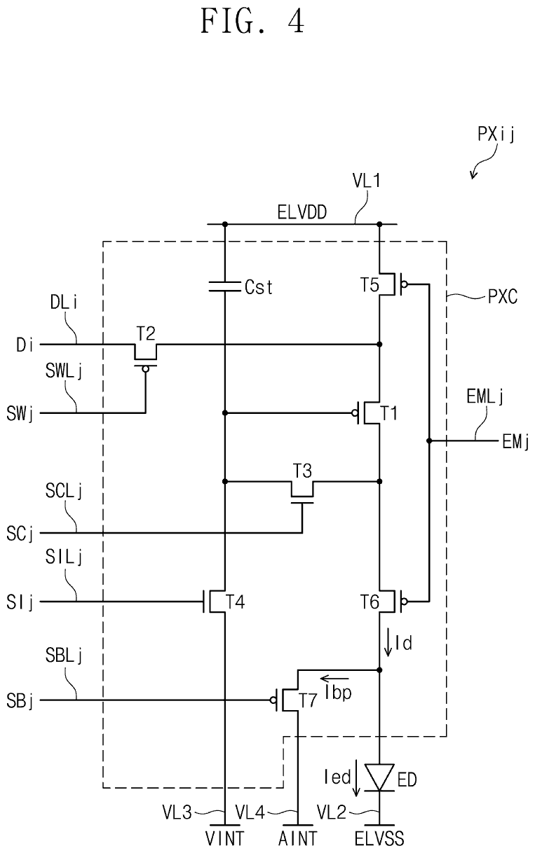

Each of the pixels PX may include a light emitting element ED (refer to FIG. 4) and a pixel circuit PXC (refer to FIG. 4) that controls a light emission of the light emitting element ED. The pixel circuit PXC may include a plurality of transistors and a capacitor. The scan driver 300 and the light emission driver 350 may include transistors that are formed through a same processes as the pixel circuit PXC.

Each of the Pixels Px May Receive the First Driving Voltage Elvdd, the Second driving voltage ELVSS, the first initialization voltage VINT, and the second initialization voltage AINT from the voltage generator 400.

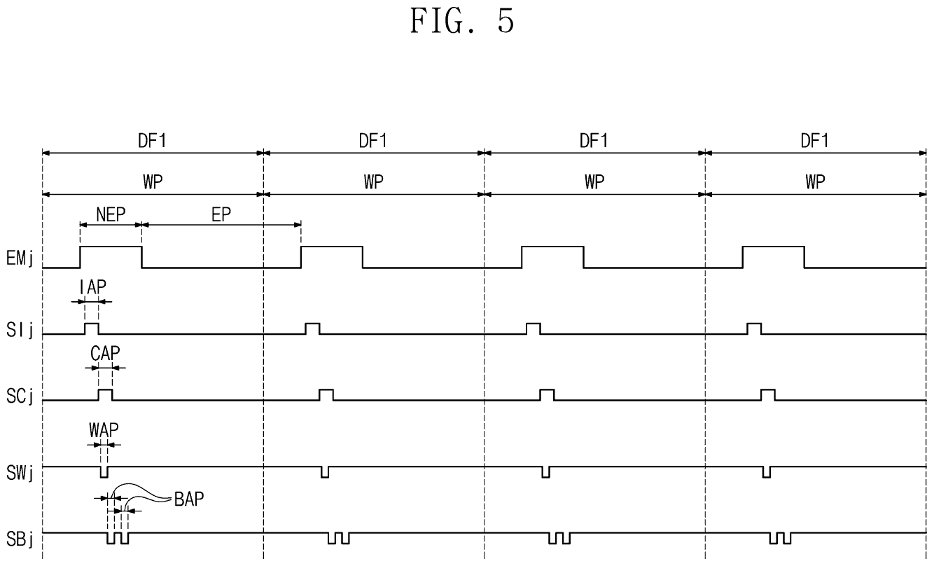

FIG. 4 is a circuit diagram illustrating a pixel according to an embodiment of the present disclosure, and FIG. 5 is a signal timing diagram illustrating an operation of the display device according to an embodiment of the present disclosure.

FIG. 4 shows an equivalent circuit diagram of one pixel PXij among the pixels shown in FIG. 3. The pixels may have a same circuit configuration as each other, and thus, the circuit configuration of one pixel PXij will be described in detail, and details of the other pixels will be omitted.

Referring to FIG. 4, the pixel PXij may be connected to an i-th data line DLi (hereinafter, referred to as a data line) among the data lines DL1 to DLm (refer to FIG. 3) and a j-th light emission control line EMLj (hereinafter, referred to as a light emission control line) among the light emission control lines EML1 to EMLn (refer to FIG. 3). The pixel PXij may be connected to a j-th initialization scan line SILj (hereinafter, referred to as an initialization scan line) among the initialization scan lines SIL1 to SILn (refer to FIG. 3), a j-th write scan line SWLj (hereinafter, referred to as a write scan line) among the write scan lines SWL1 to SWLn (refer to FIG. 3), and a j-th black scan line SBLj (hereinafter, referred to as a black scan line) among the black scan lines SBL1 to SBLn (refer to FIG. 3). In addition, the pixel PXij may be connected to a j-th compensation scan line SCLj (hereinafter, referred to as a compensation scan line) among the compensation scan lines SCL1 to SCLn (refer to FIG. 3). Here, i is a natural number less than or equal to m, and j is a natural number less than or equal to n.

The pixel PXij may include the light emitting element ED and the pixel circuit PXC. The light emitting element ED may include a light emitting diode. The light emitting diode may include an organic light emitting material, an inorganic light emitting material, a quantum dot, or a quantum rod as its light emitting layer.

The pixel circuit PXC may include first, second, third, fourth, fifth, sixth, and seventh transistors T1, T2, T3, T4, T5, T6, and T7 and a capacitor Cst. Each of the first to seventh transistors T1 to T7 may be a transistor including a low-temperature polycrystalline silicon (LTPS) semiconductor layer. According to an embodiment, some transistors of the first to seventh transistors T1 to T7 may be a P-type transistor, and the other transistors may be an N-type transistor. In an embodiment, for example, as shown in FIG. 4, each of the first, second, fifth, sixth, and seventh transistors T1, T2, T5, T6, and T7 among the first to seventh transistors T1 to T7 may be the P-type transistor, and each of the third and fourth transistors T3 and T4 may be the N-type transistor including an oxide semiconductor as its semiconductor layer. However, the configuration of the pixel circuit PXC should not be limited to the embodiment shown in FIG. 4. The pixel circuit PXC shown in FIG. 4 is merely an example, and the configuration of the pixel circuit PXC may be changed. In another embodiment, for example, all the first to seventh transistors T1 to T7 may be the P-type transistor or the N-type transistor. In addition, the number of the transistors and the number of the capacitors, which are included in the pixel circuit PXC, should not be particularly limited and may be modified in various ways.

The initialization scan line SILj, the compensation scan line SCLj, the write scan line SWLj, the black scan line SBLj, and the light emission control line EMLj may transmit a j-th initialization scan signal SIj (hereinafter, referred to as an initialization scan signal), a j-th compensation scan signal SCj (hereinafter, referred to as a compensation scan signal), a j-th write scan signal SWj (hereinafter, referred to as a write scan signal), a j-th black scan signal SBj (hereinafter, referred to as a black scan signal), and a j-th light emission control signal EMj (hereinafter, referred to as a light emission control signal) to the pixel PXij, respectively. data line DLi may transmit an i-th data signal Di to the pixel PXij. The i-th data signal Di may have a voltage level corresponding to a grayscale of a corresponding image signal among the image signal RGB input to the display device DD (refer to FIG. 3). First, second, third, and fourth driving voltage lines VL1, VL2, VL3, and VL4 may transmit the first driving voltage ELVDD, the second driving voltage ELVSS, the first initialization voltage VINT, and the second initialization voltage AINT to the pixel PXij, respectively.

The first transistor T1 may include a first electrode connected to the first driving voltage line VL1 via the fifth transistor T5, a second electrode electrically connected to an anode of the light emitting element ED via the sixth transistor T6, and a gate electrode connected to one end (or a first electrode) of the capacitor Cst. The first transistor T1 may receive the i-th data signal Di transmitted via the data line DLi based on a switching operation of the second transistor T2 and may supply a driving current Id to the light emitting element ED.

The second transistor T2 may include a first electrode connected to the data line DLi, a second electrode connected to the first electrode of the first transistor T1, and a gate electrode connected to the write scan line SWLj. The second transistor T2 may be turned on in response to the write scan signal SWj received via the write scan line SWLj and may transmit the i-th data signal Di received via the data line DLi to the first electrode of the first transistor T1.

The third transistor T3 may include a first electrode connected to the second electrode of the first transistor T1, a second electrode connected to the gate electrode of the first transistor T1, and a gate electrode connected to the compensation scan line SCLj. The third transistor T3 may be turned on in response to the compensation scan signal SCj received via the compensation scan line SCLj and may connect the gate electrode and the second electrode of the first transistor T1 to each other to allow the first transistor T1 to be connected in a diode configuration.

The fourth transistor T4 may include a first electrode connected to the gate electrode of the first transistor T1, a second electrode connected to the third driving voltage line VL3 to which the first initialization voltage VINT is transmitted, and a gate electrode connected to the initialization scan line SILj. The fourth transistor T4 may be turned on in response to the initialization scan signal SIj received via the initialization scan line SILj and may transmit the first initialization voltage VINT to the gate electrode of the first transistor T1 to perform an initialization operation that initializes a voltage of the gate electrode of the first transistor T1.

The fifth transistor T5 may include a first electrode connected to the first driving voltage line VL1, a second electrode connected to the first electrode of the first transistor T1, and a gate electrode connected to the light emission control line EMLj.

The sixth transistor T6 may include a first electrode connected to the second electrode of the first transistor T1, a second electrode connected to the anode of the light emitting element ED, and a gate electrode connected to the light emission control line EMLj.

The fifth transistor T5 and the sixth transistor T6 may be substantially simultaneously turned on in response to the light emission control signal EMj received via the light emission control line EMLj. The first driving voltage ELVDD received via the turned-on fifth transistor T5 may be compensated for by the first transistor T1 connected in the diode configuration and may be transmitted to the light emitting element ED. The fifth transistor T5 and the sixth transistor T6 may be referred to as a light emission control transistor.

The seventh transistor T7 may include a first electrode connected to the second electrode of the sixth transistor T6, a second electrode connected to the fourth driving voltage line VL4 to which the second initialization voltage AINT is transmitted, and a gate electrode connected to the black scan line SBLj. The seventh transistor T7 may be referred to as a black transistor.

As described above, the one end of the capacitor Cst may be connected to the gate electrode of the first transistor T1, and the other end (or a second electrode) of the capacitor Cst may be connected to the first driving voltage line VL1. A cathode of the light emitting element ED may be connected to the second driving voltage line VL2 that transmits the second driving voltage ELVSS.

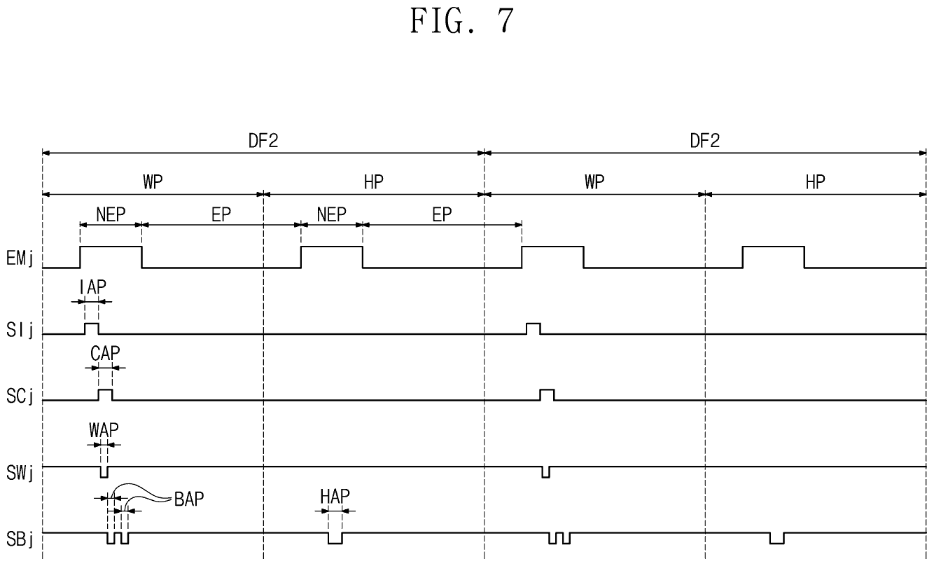

Referring to FIGS. 4 and 5, the display panel DP (refer to FIG. 3) may operate in a normal frequency mode in which a driving frequency is fixed, i.e., the driving frequency does not vary, or in a variable frequency mode in which the driving frequency varies. In the variable frequency mode, the driving frequency may vary based on (or depending on) a frame rate. FIG. 5 illustrates a signal timing diagram in which the display panel DP operates at a first driving frequency in the variable frequency mode, and FIG. 7 illustrates a signal timing diagram in which the display panel DP operates at a second driving frequency in the variable frequency mode.

In a case where the display panel DP (refer to FIG. 3) operates at the first driving frequency, the display panel DP may display images during a first driving frame DF1. The first driving frame DF1 may include a write frame WP.

The scan signals SIj, SCj, SWj, and SBj may be activated during the first driving frame DF1. In detail, in the first driving frame DF1, the initialization scan signal SIj may include an initialization activation period IAP having a high level, and the compensation scan signal SCj may include a compensation activation period CAP having the high level. In the first driving frame DF1, the write scan signal SWj may include a write activation period WAP having a low level, and the black scan signal SBj may include a black activation period BAP having the low level. The black activation period BAP may include multiple activation periods. In an embodiment, for example of the present disclosure, the black activation period BAP may include two activation periods in the first driving frame DF1, however, the present disclosure should not be limited thereto or thereby. According to another embodiment, the black activation period BAP may include one or three or more activation periods in the first driving frame DF1.

When the initialization scan signal SIj at the high level is provided through the initialization scan line SILj during the initialization activation period IAP, the fourth transistor T4 may be turned on in response to the initialization scan signal SIj at the high level. Accordingly, the first initialization voltage VINT may be applied to the gate electrode of the first transistor T1 through the turned-on fourth transistor T4, and the gate electrode of the first transistor T1 may be initialized by the first initialization voltage VINT.

Then, when the compensation scan signal SCj at the high level is provided through the compensation scan line SCLj during the compensation activation period CAP, the third transistor T3 may be turned on. During the compensation activation period CAP, the first transistor T1 may be connected in a diode configuration by the turned-on third transistor T3 and may be forward biased. The compensation activation period CAP of the compensation scan signal SCj may not overlap the initialization activation period IAP of the initialization scan signal SIj. In addition, the initialization activation period IAP of the initialization scan signal SIj may precede the compensation activation period CAP of the compensation scan signal SCj.

In an embodiment where the third and fourth transistors T3 and T4 are the P-type transistor, the compensation activation period CAP of the compensation scan signal SCj may be defined as a period where the compensation scan signal SCj has the low level, and the initialization activation period IAP of the initialization scan signal SIj may be defined as a period where the initialization scan signal SIj has the low level.

The compensation activation period CAP may overlap the write activation period WAP in which the write scan signal SWj is generated at the low level. The second transistor T2 may be turned on in response to the write scan signal SWj at the low level during the write activation period WAP. Then, a compensation voltage (Di-Vth) reduced by a threshold voltage (Vth) of the first transistor T1 from the data signal Di provided via the data line DLi may be applied to the gate electrode of the first transistor T1. That is, an electric potential of the gate electrode of the first transistor T1 may be the compensation voltage (Di-Vth).

The first driving voltage ELVDD and the compensation voltage Di-Vth may be respectively applied to opposite ends of the capacitor Cst, and the capacitor Cst may be charged with electric charges corresponding to a difference in voltage between the opposite ends of the capacitor Cst.

Then, the seventh transistor T7 may be turned on in response to the black scan signal SBj at the low level, which is received through the black scan line SBLj, during the black activation period BAP. A portion of the driving current Id may be bypassed as a bypass current Ibp via the seventh transistor T7.

In a case where the pixel PXij displays a black image, if the light emitting element ED emits a light even when a minimum driving current of the first transistor T1 flows as the driving current Id, the pixel PXij may not properly display the black image. Therefore, the seventh transistor T7 of the pixel PXij according to an embodiment of the present disclosure may divert a portion of the minimum driving current of the first transistor T1 to a current path other than a current path leading to the light emitting element ED as a bypass current Ibp. In this case, the minimum driving current of the first transistor T1 refers to a current flowing to the first transistor T1 under a condition in which a gate-source voltage (Vgs) of the first transistor T1 is lower than the threshold voltage (Vth) and thus the first transistor T1 is turned off. In this way, when the minimum driving current that turns off the first transistor T1, for example, a current of less than about 10 picoampere (pA), is transmitted to the light emitting element ED, an image with a black grayscale may be displayed. In a case where the pixel PXij displays the black image, the influence of the bypass current Ibp on the minimum driving current is relatively large, however, in the case where images, such as a normal image or a white image, are displayed, the influence of the bypass current Ibp on the driving current Id may be almost negligible. Accordingly, when the black image is displayed, a current, i.e., a light emission current Ied, reduced by an amount of the bypass current Ibp, which is bypassed through the seventh transistor T7, from the driving current Id, may be provided to the light emitting element ED, and thus, the black image may be clearly displayed. Thus, the pixel PXij may display a precise black grayscale image using the seventh transistor T7, and as a result, a contrast ratio may be improved.

The light emission control signal EMj provided from the light emission control line EMLj may include a light emission period EP and a non-light-emission period NEP. In an embodiment, for example, the light emission period EP may be a low-level period, and the non-light-emission period NEP may be a high-level period. The non-light-emission period NEP of the light emission control signal EMj may overlap the activation periods IAP, CAP, WAP, and BAP in the first driving frame DF1. The light emission period EP of the light emission control signal EMj may not overlap the activation periods IAP, CAP, WAP, and BAP.

The fifth transistor T5 and the sixth transistor T6 may be turned on in response to the light emission control signal EMj at the low level. Then, the driving current Id may be generated due to the difference between the gate voltage of the gate electrode of the first transistor T1 and the first driving voltage ELVDD, and the driving current Id may be supplied to the light emitting element ED through the sixth transistor T6. Therefore, the light emission current Ied may flow through the light emitting element ED during the light emission period EP, and as a result, the light having luminance corresponding to the light emission current Ied may be output from the light emitting element ED.

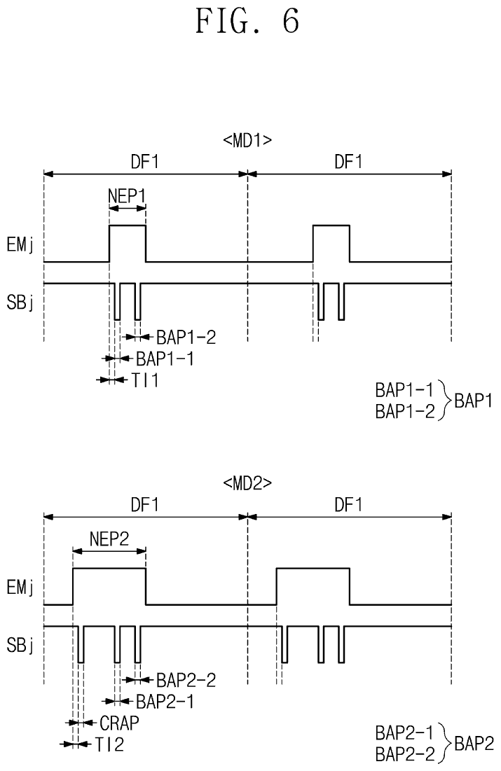

FIG. 6 is a signal timing diagram illustrating a variation of the light emission control signal and the black scan signal based on a mode according to an embodiment of the present disclosure.

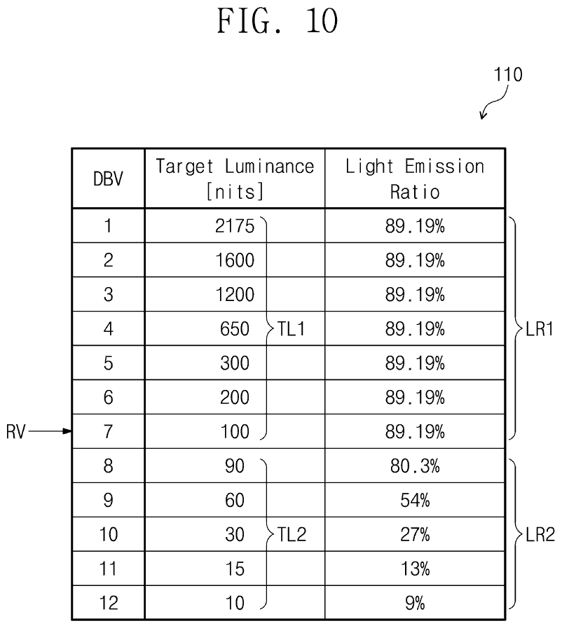

Referring to FIGS. 5 and 6, the display panel DP (refer to FIG. 3) may operate in a first mode MD1 or a second mode MD2. In an embodiment, for example of the present disclosure, the first mode MD1 may be a mode in which the pixel PXij emits the light at a first target luminance TL1 (refer to FIG. 10), and the second mode MD2 may be a mode in which the pixel PXij emits the light at a second target luminance TL2 (refer to FIG. 10). The second target luminance TL2 may be lower than the first target luminance TL1. That is, the second mode MD2 may be the mode in which the pixel PXij emits the light at a lower luminance that the light emitted in the first mode MD1.

The light emission control signal EMj may include the non-light-emission period NEP with the high level and the light emission period EP with the low level. Hereinafter, the non-light-emission period NEP of the light emission control signal EMj in the first mode MD1 is defined as a first non-light-emission period NEP1, and the non-light-emission period NEP of the light emission control signal EMj in the second mode MD2 is defined as a second non-light-emission period NEP2.

The first non-light-emission period NEP1 may have a first duration, and the second non-light-emission period NEP2 may have a second duration. In an embodiment, for example, the second duration may be longer than the first duration. The display device DD (refer to FIG. 3) may control the duration of the non-light-emission period of the light emission control signal EMj to adjust the luminance of the pixel PXij. In the first driving frame DF1, a start point of the second non-light-emission period NEP2 may precede a start point of the first non-light-emission period NEP1 to allow the second duration to be longer than the first duration. However, the present disclosure should not be limited thereto or thereby, and an end point of the second non-light-emission period NEP2 may come after an end point of the first non-light-emission period NEP1 to allow the second duration to be longer than the first duration. As described above, in the case where the second duration of the second non-light-emission period NEP2 in the second mode MD2 is longer than the first duration of the first non-light-emission period NEP1 in the first mode MD1, the duration of the light emission period in the second mode MD2 may be relatively shorter than the duration of the light emission period in the first mode MD1. As the duration of the light emission period becomes shorter, a time during which current flows through the light emitting element ED (refer to FIG. 4) of each pixel may decrease, and thus, the pixel PXij may emit the light at a lower brightness in the second mode MD2 than in the first mode MD1.

The black scan signal SBj may include the black activation period BAP having the low level. Hereinafter, the black activation period BAP of the black scan signal SBj in the first mode MD1 is defined as a first activation period BAP1, and the black activation period BAP of the black scan signal SBj in the second mode MD2 is defined as a second activation period BAP2.

The first activation period BAP1 may overlap the first non-light-emission period NEP1 of the light emission control signal EMj, and a correction activation period CRAP and the second activation period BAP2 may overlap the second non-light-emission period NEP2 of the light emission control signal EMj.

The first activation period BAP1 may include a first-first activation period BAP1-1 and a first-second activation period BAP1-2. The first-first activation period BAP1-1 may precede the first-second activation period BAP1-2. Hereinafter, a start point of the first activation period BAP1 refers to a start point of the first-first activation period BAP1-1. The start point of the first non-light-emission period NEP1 may have a first time interval TI1 with respect to the start point of the first activation period BAP1.

The second activation period BAP2 may include a second-first activation period BAP2-1 and a second-second activation period BAP2-2. The second-first activation period BAP2-1 may precede the second-second activation period BAP2-2. The correction activation period CRAP may precede the second activation period BAP2. The start point of the second non-light-emission period NEP2 may have a second time interval TI2 with respect to a start point of the correction activation period CRAP. The first time interval TI1 may be the same as the second time interval TI2.

The duration of the non-light-emission period of the light emission control signal EMj may increase to allow the display panel DP (refer to FIG. 3) to operate in the second mode MD2. Accordingly, a time interval between a start point of the non-light-emission period of the light emission control signal EMj and a start point of the activation period of the black scan signal SBj may increase, and the pixel PX (refer to FIG. 3) may experience a delay in the time to display the black image. However, according to an embodiment of the present disclosure, while operating in the second mode MD2, the black scan signal SBj further includes the correction activation period CRAP, and thus, the time interval between the start point of the non-light-emission period of the light emission control signal EMj and the start point of the activation period of the black scan signal SBj may be constant regardless of whether the display panel DP is in the first mode MD1 and the second mode MD2. In such an embodiment, as described above, even when the duration of the non-light-emission period of the light emission control signal EMj increases, the time spent for the pixel to display the black image may not be delayed. An anode electrode of the light emitting element may be initialized at the same time regardless of the mode, so the display quality of the display device may be improved.

FIG. 7 is a signal timing diagram illustrating an operation of the display device according to an embodiment of the present disclosure.

Referring to FIG. 7, when the display panel DP (refer to FIG. 3) operates at the second driving frequency, the display panel DP may display the image during a second driving frame DF2. The first driving frequency may be higher than the second driving frequency. In an embodiment, for example, the first driving frequency may be twice the second driving frequency, however, the present disclosure should not be limited thereto or thereby. In an embodiment, for example, the second driving frequency may be one-third, one-fourth, or one-sixth of the first driving frequency. The second driving frame DF2 may include a write frame WP and a holding frame HP. The second driving frame DF2 may further include the holding frame HP compared to the first driving frame DF1 illustrated in FIG. 5. The number of the holding frames may vary depending on the value of the second driving frequency. The write frame WP of the second driving frame DF2 is similar to the write frame WP of the first driving frame DF1, and thus, any repetitive detailed description of the write frame WP of the second driving frame DF2 will be omitted.

During the write frame WP, the scan signals SIj, SCj, SWj, and SBj may be activated. During the holding frame HP, the light emission control signal EMj and the black scan signal SBj may be activated, and the scan signals SIj, SCj, and SWj except the black scan signal SBj may be deactivated. That is, the light emission control signal EMj and the black scan signal SBj may have the same frequency as the first driving frequency, and the scan signals SIj, SCj, and SWj except the black scan signal SBj may have the same frequency as the second driving frequency. The black scan signal SBj may include the black activation period BAP during the write frame WP and may include a holding activation period HAP during the holding frame HP. The black activation period BAP may include two activation periods, and the holding activation period HAP may include one activation period. However, the present disclosure should not be limited thereto or thereby, and the number and duration of the activation periods included in the black activation period BAP and the holding activation period HAP may be freely set.

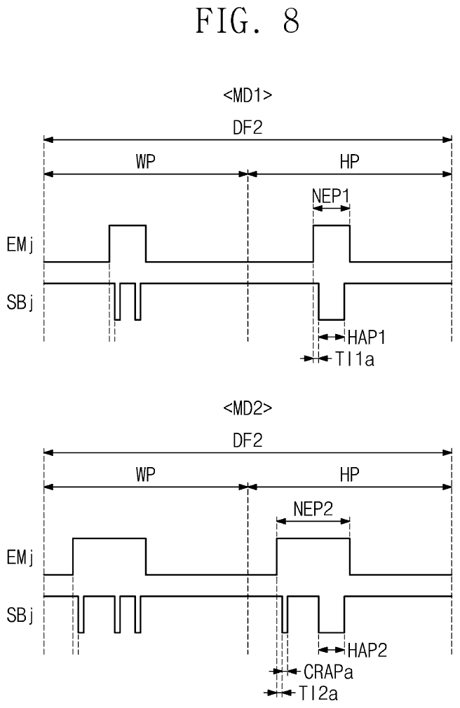

FIG. 8 is a signal timing diagram illustrating a variation of the light emission control signal EMj and the black scan signal SBj based on a mode according to an embodiment of the present disclosure

Referring to FIGS. 7 and 8, during the holding frame HP, the light emission control signal EMj may include the first non-light-emission period NEP1 in the first mode MD1 and may include the second non-light-emission period NEP2 in the second mode MD2.

The black scan signal SBj may include the holding activation period HAP having the low level. Hereinafter, the holding activation period HAP of the black scan signal SBj in the first mode MD1 is defined as a first holding activation period HAP1, and the holding activation period HAP of the black scan signal SBj in the second mode MD2 is defined as a second holding activation period HAP2. The first holding activation period HAP1 may overlap the first non-light-emission period NEP1 of the light emission control signal EMj, and a correction activation period CRAPa and the second holding activation period HAP2 may overlap the second non-light-emission period NEP2 of the light emission control signal EMj.

The start point of the first non-light-emission period NEP1 may have a first time interval TI1a with respect to a start point of the first holding activation period HAP1. The start point of the second non-light-emission period NEP2 may have a second time interval TI2a with respect to a start point of the correction activation period CRAPa. The first time interval TI1a may be the same as the second time interval TI2a.

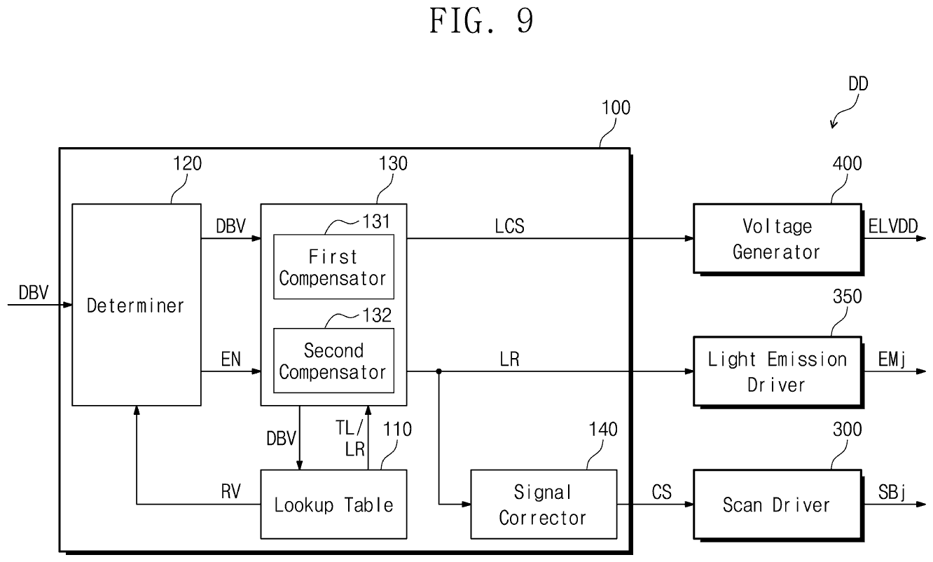

FIG. 9 is a block diagram illustrating the driving controller according to an embodiment of the present disclosure. FIG. 10 is a lookup table according to an embodiment of the present disclosure.

Referring to FIGS. 9 and 10, an embodiment of the driving controller 100 may include the lookup table 110, a determiner 120, a compensator 130, and a signal corrector 140.

The lookup table 110 may store a plurality of luminance adjustment values, a plurality of target luminances corresponding to the luminance adjustment values, and a plurality of light emission ratios corresponding to the target luminances. One of the luminance adjustment values may be set as a reference value RV.

In the disclosure, when a luminance adjustment value DBV is greater than or equal to the reference value RV, a target luminance TL corresponding to the luminance adjustment value DBV may be referred to as the first target luminance TL1, and a light emission ratio LR corresponding to the first target luminance TL1 may be referred to as a first light emission ratio LR1. In addition, when the luminance adjustment value DBV is smaller than the reference value RV, the target luminance TL corresponding to the luminance adjustment value DBV may be referred to as the second target luminance TL2, and the light emission ratio LR corresponding to the second target luminance TL2 may be referred to as a second light emission ratio LR2. In an embodiment, for example, as shown in FIG. 10, the reference value RV may be 7, and the target luminance (referred to as a reference luminance) corresponding to the luminance adjustment value DBV having the reference value RV may be 100 nits or candela per square meter (cd/m²). That is, the first target luminance TL1 may be a target luminance greater than or equal to the reference luminance, and the second target luminance TL2 may be a target luminance smaller than the reference luminance.

The first light emission ratio LR1 corresponding to the first target luminance TL1 may be constant independently of the first target luminance TL1. In this case, the first target luminance TL1 may be within a range from about 100 nits to about 2175 nits. As shown in FIG. 10, when the target luminance TL is greater than or equal to 100 nits corresponding to the reference luminance, the first light emission ratio LR1 corresponding to the first target luminance TL1 may remain constant at about 89.19%. The second light emission ratio LR2 corresponding to the second target luminance TL2 may vary depending on the second target luminance TL2. In an embodiment, for example, the second target luminance TL2 may be within a range from about 10 nits to about 90 nits. In such an embodiment, as the second target luminance TL2 decreases, the second light emission ratio LR2 corresponding to the second target luminance TL2 may decrease.

The determiner 120 may receive the luminance adjustment value DBV from the host processor and the reference value RV from the lookup table 110. The determiner 120 may output the luminance adjustment value DBV and an enable signal EN to the compensator 130. The determiner 120 may determine whether the luminance adjustment value DBV is greater than or equal to the reference value RV. When the luminance adjustment value DBV is greater than or equal to the reference value RV, the enable signal EN may be activated, and when the luminance adjustment value DBV is smaller than the reference value RV, the enable signal EN may be deactivated.

The compensator 130 may receive the luminance adjustment value DBV and the enable signal EN from the determiner 120. The compensator 130 may output the luminance adjustment value DBV to the lookup table 110. The compensator 130 may receive the target luminance TL and the light emission ratio LR, which correspond to the luminance adjustment value DBV, from the lookup table 110. The compensator 130 may include a first compensator 131 and a second compensator 132. When the luminance adjustment value DBV is greater than or equal to the reference value RV and the enable signal EN is activated, the first compensator 131 may be activated, and when the luminance adjustment value DBV is smaller than the reference value RV and the enable signal EN is deactivated, the second compensator 132 may be activated.

When the first compensator 131 is activated, the compensator 130 may generate a luminance control signal LCS based on the first target luminance TL1 and may output the luminance control signal LCS to the voltage generator 400. When the luminance adjustment value DBV is greater than or equal to the reference value RV, the first light emission ratio LR1 is constant even though the value of the first target luminance TL1 varies, and thus, the duration of the light emission period of the light emission control signal EMj corresponding to the value of the first target luminance TL1 may be constant. The compensator 130 may control the first driving voltage ELVDD of the voltage generator 400 through the luminance control signal LCS to allow the pixel PXij (refer to FIG. 4) to emit light at the first target luminance TL1.

When the second compensator 132 is activated, the compensator 130 may output the light emission ratio LR to the light emission driver 350 and the signal corrector 140. The light emission driver 350 may set the duration of the non-light-emission period of the light emission control signal EMj based on the second light emission ratio LR2. Accordingly, the pixel PXij (refer to FIG. 4) may emit the light at the second target luminance TL2.

That is, when the luminance adjustment value DBV is greater than or equal to the reference value RV, the first compensator 131 may correct the luminance of the pixel PXij using the luminance control signal LCS, and when the luminance adjustment value DBV is smaller than the reference value RV, the second compensator 132 may correct the luminance of the pixel PXij using the light emission ratio LR.

The signal corrector 140 may receive the light emission ratio LR from the compensator 130 when the second compensator 132 is activated. The signal corrector 140 may output a correction signal CS based on the light emission ratio LR. The correction signal CS may be a signal that generates the black scan signal SBj in the second mode MD2 to allow the time interval between the start point of the non-light-emission period of the light emission control signal EMj and the start point of the activation period of the black scan signal SBj to be the same in both the first and second modes MD1 and MD2 (refer to FIG. 6). That is, the scan driver 300 may receive the correction signal CS, may generate the black scan signal SBj including the correction activation period CRAP (refer to FIG. 6) based on the correction signal CS, and may output the black scan signal SBj.

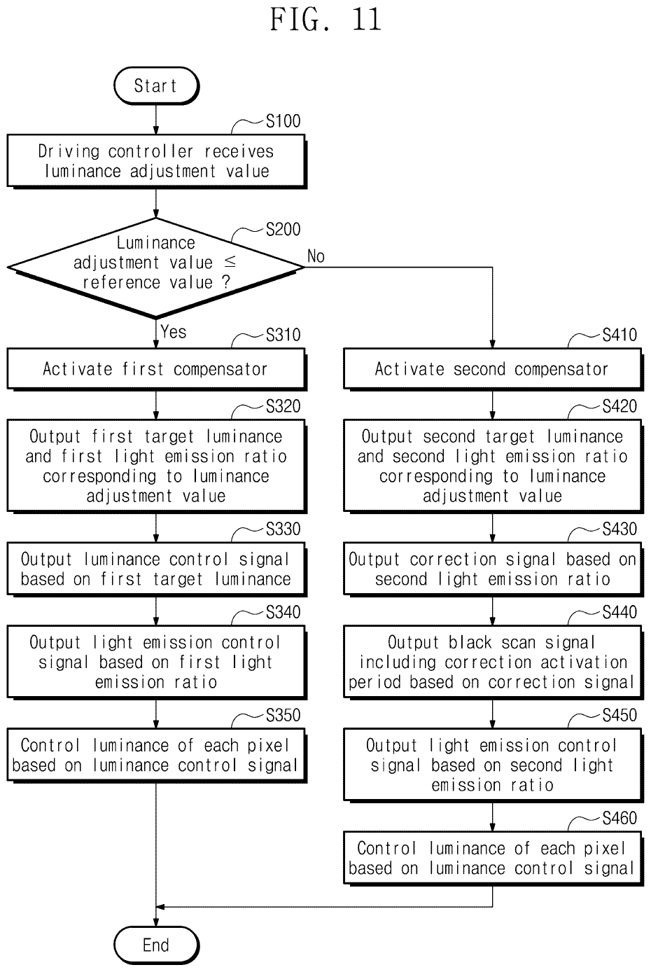

FIG. 11 is a flowchart illustrating an operation of (or a method of driving) the display device according to an embodiment of the present disclosure.

Referring to FIGS. 3, 9, and 11, in an embodiment of a method of driving the display device, the driving controller 100 may receive the luminance adjustment value DBV (S100). Then, the determiner 120 may compare the luminance adjustment value DBV to the reference value RV (S200).

As a result of comparing the luminance adjustment value DBV with the reference value RV, when the luminance adjustment value DBV is greater than or equal to the reference value RV, the first compensator 131 may be activated (S310). The first compensator 131 may output the luminance adjustment value DBV to the lookup table 110, and the lookup table 110 may output the target luminance TL and the light emission ratio LR, which correspond to the luminance adjustment value DBV, to the first compensator 131 as the first target luminance TL1 and the first light emission ratio LR1 (S320). The first compensator 131 may output the luminance control signal LCS based on the first target luminance TL1 (S330). The light emission driver 350 may output the light emission control signal EMj based on the first light emission ratio LR1 (S340). The luminance of each of the pixels may be controlled based on the luminance control signal LCS (S350).

As a result of comparing the luminance adjustment value DBV with the reference value RV, when the luminance adjustment value DBV is smaller than the reference value RV, the second compensator 132 may be activated (S410). The second compensator 132 may output the luminance adjustment value DBV to the lookup table 110, and the lookup table 110 may output the target luminance TL and the light emission ratio LR, which correspond to the luminance adjustment value DBV, to the second compensator 132 as the second target luminance TL2 and the second light emission ratio LR2 (S420). The signal corrector 140 may output the correction signal CS based on the second light emission ratio LR2 (S430). The scan driver 300 may output the black scan signal SBj including the correction activation period CRAP (refer to FIG. 6) based on the correction signal CS (S440). The light emission driver 350 may output the light emission control signal EMj based on the light emission ratio LR (S450). The luminance of each of the pixels may be controlled based on the light emission control signal EMj (S460).

The display device may be applied to various electronic devices. The electronic device may include the display device and may further include a module or device having additional functions in addition to the display device.

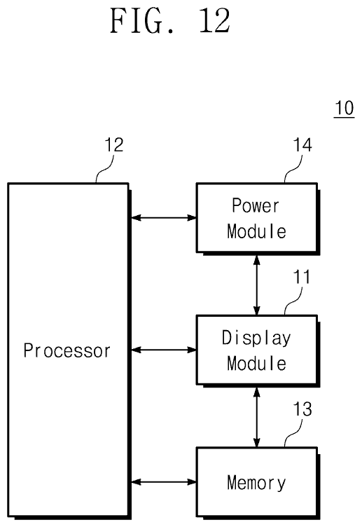

FIG. 12 is a block diagram illustrating the electronic device according to an embodiment of the present disclosure. Referring to FIG. 12, an embodiment of the electronic device 10 may include a display module 11, a processor 12, a memory 13, and a power module 14.

The processor 12 may include at least one selected from a central processing unit (CPU), an application processor (AP), a graphics processing unit (GPU), a communication processor (CP), an image signal processor (ISP), and a controller. The processor 12 may control the operation of the display device according to embodiments of the present disclosure.

The memory 13 may store data information used for the operation of the processor 12 or the display module 11. When the processor 12 executes an application stored in the memory 13, an image data signal and/or an input control signal may be transmitted to the display module 11, and the display module 11 may process the received signals to output image information through a display screen.

The power module 14 may include a power supply module, such as a power adapter or a battery device, and a power conversion module that converts power supplied by the power supply module to generate power used for the operation of the electronic device 10.

The electronic device 10 may include the display device according to the embodiments described above, and at least one of components of the electronic device 10 may be included in the display device according to embodiments. In addition, among individual modules that are functionally included within a single module, some may be included in the display device while others may be provided separately from the display device. In an embodiment, for example, the display device may include the display module 11, and the processor 12, the memory 13, and the power module 14 may be provided as separate devices within the electronic device 10, rather than being included in the display device.

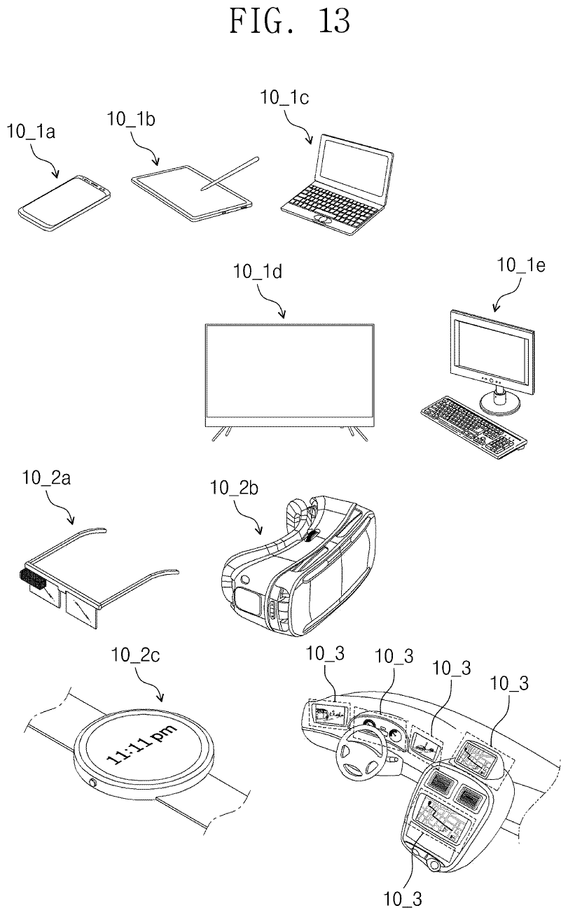

FIG. 13 are schematic views illustrating electronic devices according to various embodiments of the present disclosure.

Referring to FIG. 13, various electronic devices to which the display device according to embodiments is applied may include an electronic device for displaying images, such as a smartphone 10_1a, a tablet personal computer (PC) 10_1b, a laptop computer 10_1c, a television 10_1d, a desktop monitor 10_1e, etc., a wearable electronic device including a display module, such as a smart glasses 10_2a, a head-mounted display 10_2b, a smartwatch 10_2c, etc., and an in-vehicle electronic device 10_3 including a display module, such as an instrument panel, a center fascia, a dashboard-mounted center information display (CID), a room mirror display, etc.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display device comprising:
a pixel which operates in a first mode or a second mode;
a scan driver which applies a black scan signal to the pixel; and
a light emission driver which applies a light emission control signal to the pixel,
wherein the light emission control signal comprises a first non-light-emission period in the first mode and a second non-light-emission period in the second mode,
the first non-light-emission period has a duration different from a duration of the second non-light-emission period,
the black scan signal comprises a first activation period in the first mode,
the black scan signal comprises a second activation period and a correction activation period in the second mode, and
a time interval between a start point of the first non-light-emission period and a start point of the first activation period is equal to a time interval between a start point of the second non-light-emission period and a start point of the correction activation period.

2. The display device of claim 1, wherein
the first activation period overlaps the first non-light-emission period in the first mode, and
the second activation period and the correction activation period overlap the second non-light-emission period in the second mode.

3. The display device of claim 2, wherein the correction activation period precedes the second activation period in the second mode.

4. The display device of claim 3, wherein the first activation period is the earliest activation period among a plurality of activation periods included in the black scan signal during a driving frame in the first mode.

5. The display device of claim 1, wherein the duration of the first non-light-emission period is shorter than the duration of the second non-light-emission period.

6. The display device of claim 5, wherein
the pixel emits a light at a first target luminance in the first mode and emits a light at a second target luminance in the second mode, and
the first target luminance is higher than the second target luminance.

7. The display device of claim 6, wherein
the first target luminance is greater than or equal to a reference luminance, and
the second target luminance is smaller than the reference luminance.

8. The display device of claim 6, wherein the pixel emits the light at a lower luminance as the duration of the first non-light-emission period and the duration of the second non-light-emission period become longer.

9. The display device of claim 1, further comprising:
a driving controller which controls an operation of the scan driver and the light emission driver,
wherein the driving controller comprises:
a determiner which receives a luminance adjustment value and determines whether the luminance adjustment value is greater than or equal to a reference value;
a first compensator which corrects a luminance of the pixel when the luminance adjustment value is greater than or equal to the reference value;
a second compensator which corrects the luminance of the pixel when the luminance adjustment value is smaller than the reference value; and
a lookup table which stores a plurality of luminance adjustment values, a plurality of target luminances corresponding to the luminance adjustment values, and a plurality of light emission ratios corresponding to the target luminances.

10. The display device of claim 9, wherein
the first compensator corrects the luminance of the pixel using a luminance control signal, and
the second compensator corrects the luminance of the pixel using the light emission ratios.

11. The display device of claim 10, wherein the duration of the first non-light-emission period and the duration of the second non-light-emission period of the light emission control signal are set based on the light emission ratios.

12. The display device of claim 11, wherein
the duration of the first non-light-emission period is constant independently of the luminance adjustment value in the first mode, and
the duration of the second non-light-emission period is changed depending on the luminance adjustment value in the second mode.

13. The display device of claim 12, wherein the luminance adjustment values greater than or equal to the reference value correspond to a same light emission ratio in the lookup table.

14. The display device of claim 1, wherein the display device operates at a first driving frequency during a first driving frame or at a second driving frequency during a second driving frame.

15. The display device of claim 14, wherein
the first driving frame and the second driving frame comprise a write frame,
the light emission control signal comprises the first non-light-emission period during the write frame in the first mode,
the black scan signal comprises the first activation period during the write frame in the first mode,
the light emission control signal comprises the second non-light-emission period during the write frame in the second mode, and
the black scan signal comprises the second activation period during the write frame in the second mode.

16. The display device of claim 15, wherein
the second driving frame further comprises a holding frame,
the black scan signal comprises a first holding activation period during the holding frame in the first mode, and
the black scan signal comprises a second holding activation period during the holding frame in the second mode.

17. The display device of claim 1, wherein
the pixel comprises a light emitting element and a pixel circuit connected to the light emitting element, and
the pixel circuit comprises:
a light emission control transistor which receives the light emission control signal; and
a black transistor which receives the black scan signal.

18. A method of driving a display device, the method comprising:
allowing a driving controller to receive a luminance adjustment value;
comparing the luminance adjustment value with a reference value;
outputting a target luminance corresponding to the luminance adjustment value and a light emission ratio corresponding to the luminance adjustment value;
outputting a light emission control signal based on the light emission ratio;
outputting a correction signal based on the light emission ratio when the luminance adjustment value is smaller than the reference value; and
outputting a black scan signal comprising a correction activation period based on the correction signal.

19. The method of claim 18, wherein a time interval between a start point of a non-light-emission period of the light emission control signal and a start point of a activation period of the black scan signal is constant.

20. An electronic device comprising:
a display device; and
a processor which controls an operation of the display device,
wherein the display device comprising:
a pixel which operates in a first mode or a second mode;
a scan driver which applies a black scan signal to the pixel; and
a light emission driver which applies a light emission control signal to the pixel,
wherein the light emission control signal comprises a first non-light-emission period in the first mode and a second non-light-emission period in the second mode,
the first non-light-emission period has a duration different from a duration of the second non-light-emission period,
the black scan signal comprises a first activation period in the first mode,
the black scan signal comprises a second activation period and a correction activation period in the second mode, and
a time interval between a start point of the first non-light-emission period and a start point of the first activation period is equal to a time interval between a start point of the second non-light-emission period and a start point of the correction activation period.
